(19) United States
(12) Patent Application Publication
(10) Pub. No.: US 2012/0085613 A1
(43) Pub. Date: Apr. 12, 2012

(54) SWITCHABLE MAGNETORHEOLOGICAL TORQUE OR FORCE TRANSMISSION DEVICE, THE USE THEREOF, AND MAGNETORHEOLOGICAL TORQUE OR FORCE TRANSMISSION METHOD

(75) Inventors: Holger Böse, Wurzburg (DE); Johannes Ehrlich, Wiesenbronn (DE)

(73) Assignee: Fraunhofer-Gesellschaft zur Forderung der angewandten Forschung E.V., Munchen (DE)

(21) Appl. No.: 13/147,622

(22) PCT Filed: Feb. 2, 2010
(86) PCT No.: PCT/EP2010/000628

§ 371 Date: Nov. 22, 2011

(30) Foreign Application Priority Data
Feb. 3, 2009 (DE) 10 2009 007 209.8

(51) Int. Cl. F16D 37/02

(52) U.S. Cl. 192/21.5

(57) ABSTRACT

The present invention relates to a magnetorheological torque transmission device comprising two device parts separated by at least one transmission gap for transmitting torque, said gap being fillable and/or filled with a magnetorheological material, rotating relative to each other about an axis of rotation, wherein the magnetic circuit system of the torque transmission device comprises at least one permanent magnet having variable magnetization in addition to at least one electromagnet for generating the magnetic flux in at least one part of the transmission gap, wherein the electromagnet and the permanent magnet are designed and disposed such that the magnetization of the permanent magnet can be adjusted by changing the coil current of the electromagnet. The present invention further relates to a correspondingly designed force transmission device.

The present invention relates to a magnetorheological torque transmission device or force transmission device, use thereof and also a corresponding magnetorheological torque transmission method or force transmission method. The magnetorheological transmission device can hereby be used in particular as brake or as coupling, as shock absorber or vibration damper or as fixing or locking device.

Magnetorheological fluids (MRF) are suspensions of magnetically polarisable particles in a carrier fluid, the viscosity and other rheological properties of which can be changed rapidly and reversibly in a magnetic field. They hence offer an ideal basis for adaptive torque transmission devices (e.g. couplings or brakes), the transmitted torques of which are controlled by the magnetic field. Thus for example in a coupling, the MRF between two plates which rotate at a different speed (subsequently also termed device parts) transmits a torque from one plate (drive side) to the other (power take-off side) predominantly by shearing, the consistency of the MRF and hence the transmitted torque being influenced via the strength of the applied magnetic field. If the plate of the power take-off side is locked relative to rotation, a brake is produced with a controllable braking force. Such magnetorheological couplings and brakes are already known. Also MRF, as can be used in the present invention, are already known: patent DE 10 2004 041 650 B4, which is herewith introduced in its entirety into the disclosure of the present invention, shows such magnetorheological fluids.

In a magnetorheological (MR-) coupling, brake or damping device, the magnetic field is produced by the current in the coil of an electromagnet and guided by the magnetic circuit into the active gap (subsequently also force transmission- or torque transmission gap) in which the MRF is stiffened. MR-couplings or -brakes exert a low torque transmission without current in the coil (uncoupling or free running), whilst the torque transmission becomes ever greater with increasing coil current (coupling or braking). Without coil current, minimum torque transmission is effected by the fluid friction (drag moment). Magnetorheological damping devices exert a low damping force without current in the coil of the electromagnet (soft damping) whilst the damping force becomes ever greater with increasing coil current (hard damping). The damping force can thereby be increased so greatly (corresponding to high coil current) that complete locking is achieved.

The MR-couplings and -brakes known from the state of the art produce the magnetic field by electromagnets in the form of coils, i.e. their magnetic circuit system comprises coils for producing the magnetic flux in the torque transmission gap. It is not possible therewith to produce a desired operating state with high torque transmission without using electrical energy, and a good fail-safe behaviour of the coupling or brake is not provided since, in the case of a failure of the electrical energy supply in the coupling or brake, only the minimum torque is transmitted.

It is hence the object of the present invention to make available a magnetorheological force transmission device or torque transmission device (and also corresponding transmission methods), with which a torque to be transmitted or a force to be transmitted can be adjusted specifically and with high accuracy with as little energy expenditure as possible and with which a significantly improved fail-safe behaviour can be produced.

This object is achieved by the magnetorheological torque transmission device, the magnetorheological torque transmission method, the magnetorheological force transmission device and the magnetorheological force transmission method according to the coordinated claims 1, 31, 2 and 32. The respectively dependent claims describe advantageous embodiments in this respect. Uses according to the invention can be deduced from claim 30.

Subsequently, the present invention is firstly described in general. For both devices (or the corresponding methods), subsequently detailed embodiments are given.

The feature combinations explained concretely in the individual embodiments can be used, according to the patent claims, within the scope of the present invention, based on the expert knowledge of the person skilled in the art, also in any other combinations.

The basic idea of the solution to the object according to the invention is based on the fact that, in the magnetic circuit system of the device which is configured to produce the magnetic flux in the transmission gap (torque transmission gap or force transmission gap), not only at least one electromagnet (comprising at least one coil) should be provided but furthermore also at least one permanent magnet, the permanent magnet having a variable magnetisation and this permanent magnet with variable magnetisation and the electromagnet being configured and disposed such that the magnetisation of this permanent magnet can be adjusted by changing the coil current of the electromagnet. The magnetisation of this permanent magnet can therefore be adjusted to a desired value for example by means of a current in a coil of the electromagnet which flows only very briefly so that the transmitted force or the transmitted torque can be changed, energy requiring to be expended only briefly to change the magnetisation state of this permanent magnet.

The adjustment of the magnetic operating point (which determines the magnetic basic field when the coil current is switched off) is hence effected, in the present invention, by the provision of at least one permanent magnet with variable magnetisation, by the shape and/or arrangement thereof (relative to the arrangement of the coil of the electromagnet), and also advantageously, as described subsequently in more detail, also by the additional provision of at least one non-magnetic insert and also by the shape and/or arrangement thereof relative to the electromagnets and permanent magnets provided in the magnetic circuit (also a plurality of electromagnets and/or a plurality of such permanent magnets respectively can be provided).

In a particularly advantageous embodiment variant, the magnetic circuit system of the transmission device, which is configured to produce the magnetic flux in at least one part of the transmission gap, is configured such that it comprises, in addition to the at least one electromagnet, at least two permanent magnets with variable magnetisation, these two permanent magnets with variable magnetisation being coupled to each other magnetically via a magnetically conductive material. This advantageous variant can hence be regarded as an embodiment in which a permanent magnet present with variable magnetisation is divided into two parts which are then connected via a magnetically conducting material. The electromagnet and these two permanent magnets with variable magnetisation are in turn configured and disposed such that the magnetisation of these two permanent magnets can be adjusted by changing the coil current of the electromagnet.

Advantageously, in addition to the at least one permanent magnet with variable magnetisation, also one or more permanent magnet(s) with non-variable magnetisation is/are provided; this is described subsequently in more detail. Hence a plurality of electromagnets and/or a plurality of permanent magnets of variable and non-variable type are possible in the magnetic circuit system.

The difference between a permanent magnet with variable magnetisation and a permanent magnet with non-variable magnetisation is hereby produced, according to definition, by the coercive field strength ⱼH_{c}. Provided nothing different is said, there is understood by the term of coercive field strength, respectively the coercive field strength of the magnetic polarisation. Within the scope of the present invention, a permanent magnet with variable magnetisation is hence generally a magnet which comprises a material or consists thereof, the coercive field strength ⱼH_{c} of which is between 5 and 300 kA/m, preferably between 20 and 200 kA/m, particularly preferred between 30 and 100 kA/m. A permanent magnet with non-variable magnetisation generally comprises in contrast a material or consists thereof, the coercive field strength of which is greater than 300 kA/m, preferably greater than 500 kA/m, preferably greater than 1,000 kA/m and particularly preferred greater than 1,500 kA/m.

Within the scope of the invention, in addition to the (at least) one permanent magnet with variable magnetisation, advantageously also (at least) one permanent magnet with non-variable magnetisation is used such that the material thereof has a coercive field strength which is greater by at least the factor 2, preferably at least the factor 4, preferably at least the factor 8, preferably at least the factor 16, preferably at least the factor 32, than the coercive field strength of that material from which the permanent magnets with variable magnetisation are made.

By means of the additional permanent magnet with non-variable magnetisation, a very high current-free operating point can be adjusted. At the same time, the permanent magnet with variable magnetisation contributes to the fail-safe behaviour. The permanent magnet with non-variable magnetisation ensures a fail-safe behaviour in the demagnetised state of the permanent magnet with variable magnetisation if an electrical energy input from outside is no longer possible. By remagnetisation of the permanent magnet with variable magnetisation, only very little electrical energy from outside is required in order to achieve any operating point. The system hence operates in a very energy-efficient manner.

The extreme operating modes can be achieved by increasing or reducing the individual magnetic sources:
permanent magnet with variable magnetisation demagnetised, permanent magnet with non-variable magnetisation acts alone.
permanent magnet with variable magnetisation magnetised and increases the magnetic effect of permanent magnet with non-variable magnetisation.
permanent magnet with variable magnetisation magnetised to be opposite and reduces the magnetic effect of the permanent magnet with non-variable magnetisation.
permanent magnet with variable magnetisation magnetised and, together with the electromagnet, increases the magnetic effect of the permanent magnet with non-variable magnetisation.

The permanent magnet with variable magnetisation is preferably designed such that it is orientated, with full magnetisation, in the opposite magnetic field orientation of the permanent magnet with non-variable magnetisation so that the magnetic field in the MRF gap is eliminated.

There is suitable for the material of the permanent magnets with variable magnetisation, in particular an AlNiCo alloy or a ferrite material, e.g. a mixture of barium- or strontium oxide with iron oxide. There is suitable for the permanent magnets with non-variable magnetisation, above all SmCo alloys, such as SmCo₅ or Sm₂Co₁₇, or NdFeB alloys.

There is understood by a magnetic circuit system in the following the sum of all individual magnetic circuits or magnetic circuits of the magnetorheological transmission device. Likewise, this term stands for the sum of all individual components (e.g. for instance coils, permanent magnets, non-magnetic inserts, flow-guiding elements or yoke parts (e.g. made of iron) . . . ), which belong to the individual magnetic circuits or form these. What is respectively intended is disclosed to the person skilled in the art directly from the respective context. There is understood in the following by an individual magnetic circuit (which forms the magnetic circuit system together with the other magnetic circuits), a defined spatial region which is covered by the closed magnetic field lines of a magnetic field generator (permanent magnet or coil). The defined spatial region can thereby be covered also by the closed field lines of a plurality of magnetic field generators (the closed field lines of the plurality of field generators then extend essentially parallel to each other). It is thereby also not ruled out that the field lines of a further magnetic field generator which belongs not to the one observed but to a different magnetic circuit, likewise extend in this defined spatial region in sections. The definition of the magnetic circuit can hereby relate in particular also to a defined operating state of the system (in particular a defined current flow direction in the coil or the coils of the electromagnet or electromagnets): it is therefore not ruled out that, in the case of a different operating state, the same spatial arrangement and physical embodiment of the elements forming the system (permanent magnets, electromagnets, non-magnetic inserts . . . ) form a different magnetic circuit system. Therefore, e.g. a formulation, such as “the electromagnet is disposed in a magnetic circuit without the permanent magnet” implies subsequently that, in one of the two (according to the current flow direction in the coil of the electromagnet) possible operating states, the magnetic circuit including the electromagnet does not also include the permanent magnet without however ruling out that, in the other operating state, the permanent magnet is likewise included by this magnetic circuit. Likewise, the term of magnetic circuit comprises all those components or component parts (i.e. e.g. coil, ferromagnetic housing parts, e.g. configured as yoke parts, non-magnetic elements . . . ) of the transmission device which are covered or included by the mentioned closed field lines of the magnetic field generator.

In an advantageous embodiment, the magnetic circuit system of the transmission device comprises, in addition to the at least one coil and the at least one variable permanent magnet, in addition also at least one magnetic flux-regulating non-magnetic insert or a magnetic insulator (therefore a plurality of such inserts or insulators can be present). A magnetic insulator is a spatial element with has a permeability μ of less than 2. Magnetic insulators screen or direct the magnetic flux over defined other spatial elements.

A magnetic flux-regulating insert generally has a permeability μ of less than 10. By means of the spatial configuration of the insert, the strength but also the spatial configuration of the magnetic field is influenced.

In a further advantageous embodiment, the transmission device according to the invention is constructed such that two or three essentially separated magnetic circuits (this is described subsequently in more detail) are configured (the magnetic circuit system then consists of these two or three individual magnetic circuits).

An essential aspect of the present invention is hence that, for control of the torque transmission between the two mutually rotatable device parts of a torque transmission device or for control of the force transmission between the two device parts of a force transmission device, which are displaceable in a translatory manner relative to each other, by means of the MRF, a magnetic field is used which is produced by at least one coil and/or at least one permanent magnet with magnetisation which is variable by means of this coil, and also advantageously furthermore regulated by at least one non-magnetic insert.

By the additional use of such a permanent magnet in the magnetic circuit system, a magnetic basic field can be produced in the coil of the electromagnet even without current. By means of the coil current of the electromagnet, this magnetic field can then be either reduced or increased, as a function of the direction of the current in the coil. By means of the basic field, the variable permanent magnet alone produces a basic damping without energy use (force transmission device) or a basic torque without energy use (torque transmission device). Hence a fail-safe behaviour can be ensured in the case where the electrical energy supply fails (force transmission device) or the torque required for the normal operating state can be specified or a fail-safe behaviour ensured in the case where the electrical energy supply fails (torque transmission device).

A particularly advantageous, further aspect of the invention is that, in addition to the variable permanent magnet, also at least one further permanent magnet which is non-variable with respect to its magnetisation is provided.

Hence, the magnetic field of the permanent magnet with variable magnetisation can be either increased or reduced by the permanent magnet with non-variable magnetisation, can even be eliminated under suitable conditions without energy requiring to be used permanently by the electromagnet. The electromagnet here serves for the purpose of changing the magnetisation of the permanent magnet with variable magnetisation. Hence, a higher permanent total magnetisation is possible by the superimposition of the permanent magnets with variable and non-variable magnetisation than only by the permanent magnet with variable magnetisation.

The subject of the present invention is hence an MRF torque transmission device or MRF force transmission device, in which the magnetisation of at least one permanent magnet (variable permanent magnet) can be either increased or reduced by the current of the coil of the electromagnet or even reversed in its direction. For this purpose, the permanent magnet which is variable in its magnetisation is preferably situated in the same magnetic circuit as the coil producing this change in magnetisation. As described already above, in addition also at least one further permanent magnet, the magnetisation of which is not changed (non-variable permanent magnet) is advantageously integrated for example in a separate magnetic circuit, the magnetic flux of which is superimposed with the magnetic flux of the previously mentioned magnetic circuit comprising electromagnet/coil and variable permanent magnet, in an advantageous embodiment, in one and the same part of at least one active MRF gap (transmission gap).

The torque- or force transmission devices according to the invention, in contrast to the devices known from the state of the art, have the following particular advantages:
As a result of the combination of the coil with the variable permanent magnet, the latter can be adjusted rapidly and simply to a desired magnetisation by a brief current in the coil and hence the coupling, the brake, the damping device etc. to a desired torque to be transmitted or to a desired damping force to be transmitted, torque or damping force also being maintained after the coil current is switched off. Hence no permanent energy supply is required.
As a result of the combination of a first magnetic circuit (with coil and variable permanent magnet) with at least one further magnetic circuit (second or additionally also third magnetic circuit with one permanent magnet or rather one non-variable permanent magnet), the magnetic fluxes of both magnetic circuits (or of the three magnetic circuits) can be respectively either increased or reduced in the active MRF gap or gaps. The reduction is hereby possible with suitable spatial arrangement of the individual elements of the magnetic circuit system and with suitable configuration of the same, ideally down to a magnetic flux density of 0 in the gap, which can be achieved, in particular, by good coordination of the individual magnetic circuits and the components contained therein (permanent magnets of variable and non-variable type and coils and also possibly furthermore non-magnetic inserts, such as magnetic field-regulating inserts or magnetic insulators). Under these conditions, there is produced, on the one hand, an MRF coupling or MRF brake, the transmitted torque of which can be varied over a very wide range and, on the other hand, an MRF damper, the damping force of which can be varied over a very wide range, energy requiring to be used for current production in the coil merely for the short period of time of the variation (switching process). As long as the coupling or the brake, on the one hand, or the damper, on the other hand, is operated with a constant transmittable torque or with a constant damping force, the magnetic field is maintained solely by the permanent magnets and hence without energy supply.
In contrast to previous MRF couplings and MRF brakes, on the one hand, or MRF dampers, on the other hand, a variable transmittable torque or a variable damping force can hence be produced, with the described system, without continuous energy supply. This is of great importance in particular with couplings since the coupled state here is generally intended to be maintained for a longer time.

For this purpose, the torque transmission device or force transmission device according to the invention comprises a magnetic circuit system which comprises at least one electromagnet, at least one permanent magnet, the magnetisation of which can be varied by the coil of the electromagnet, and preferably also at least one further non-variable permanent magnet. There is possible as material for a permanent magnet with non-variable magnetisation, preferably neodymium-iron-boron or samarium-cobalt and, as material for a permanent magnet with variable magnetisation, preferably aluminium-nickel-cobalt or a ferrite material since the latter have a high saturation magnetisation and a relatively low coercive field strength.

In a preferred embodiment, the transmission device comprises at least two active MRF gaps which are disposed preferably also parallel to each other and which can preferably also have a connection to each other for transmission of the MRF from one gap into the other gap or for corresponding MRF exchange.

In a further particular embodiment, the MRF torque transmission device or the MRF force transmission device, in a symmetrical arrangement along an axis or on an axis (in the torque transmission device the axis of rotation is hereby preferably concerned) comprises an electromagnet, two permanent magnets with invariable magnetisation, a permanent magnet with variable magnetisation and two active MRF gaps. A symmetrical arrangement of the coil and of the permanent magnets on one axis is preferred, in which the coil and the permanent magnet with variable magnetisation are situated between the two permanent magnets with invariable magnetisation (quite generally, a symmetrical arrangement of the coil or coils and of the permanent magnets on one axis is preferred).

Hence, the magnetic flux guidance of the transmission device can be constructed from three magnetic circuits (which together form the magnetic circuit system): in such a magnetic circuit system, the magnetic flux produced by the coil of the electromagnet and the permanent magnet with variable magnetisation extends essentially through both active MRF gaps (transmission gaps) and not through the permanent magnets with invariable magnetisation, as a result of which the danger of depolarisation of the latter permanent magnets is avoided. In addition, the magnetic flux of each of the two permanent magnets with non-variable magnetisation extends only through respectively one of the two active MRF gaps, as a result of which a higher magnetic flux density can be produced than in the case of throughflow of the flux of one permanent magnet through both active MRF gaps.

In the present invention, the active MR gaps or torque transmission gaps can be disposed either parallel to the axis of rotation (axial design corresponding to the bell configuration known from the state of the art) or perpendicular to the axis of rotation or rotational axis (radial design corresponding to the disc configuration known from the state of the art). Furthermore, also a plurality of individual MR gaps can be disposed parallel to each other in order to increase the transmittable torque due to the greater shear surface (lamella arrangement of the walls delimiting the gaps). If subsequently a torque transmission gap is mentioned, then both the entire volume of the gap which is filled or can be filled with MRF is herewith understood and also the individual gap portions (essentially disposed parallel to each other). What is respectively intended, is disclosed to the person skilled in the art directly from the respective context.

In the case of the force transmission device, the active MRF gaps can also be designed with a greater thickness or with a greater gap width such that the mechanical resistance of the force transmission device, at the lowest magnetic field strength (invariable permanent magnets and a permanent magnet which can be changed by the electromagnet are compensated for optimally), is reduced and hence the switching factor of the damper (damping force at maximum field strength relative to the damping force with minimal field strength) is significantly increased. In particular, gap diameters or gap thicknesses here are advantageously in the mm range.

Further embodiments of the torque transmission device according to the invention involve using, as controllable material instead of the MRF, a magnetorheological gel (MRG), a magnetorheological elastomer (MRE) or a magnetorheological foam (MRS). An MRG is a material which, in contrast to an MRF, is in fact soft but not liquid. Analogously to an MRF, it can be irreversibly deformed in any way and stiffened in the magnetic field analogously to an MRF. An MRE is a crosslinked material which has therefore a prescribed shape from which it can be deformed reversibly only to a limited extent. An MRS is an elastomer foam, the pores of which are filled with an MRF. Like MRE, an MRS also has a prescribed shape from which it can be deformed reversibly only to a limited extent.

Possible applications of the torque transmission device according to the invention are electrically controllable couplings and brakes and also dynamic dampers in which the transmitted torque is produced by the magnetic field of the permanent magnets permanently without energy supply. As a result of a brief current in the coil of the electromagnet, the magnetisation of the variable permanent magnets can be modified and hence the transmittable torque permanently changed. Possible applications of the force transmission device according to the invention are electrically controllable shock absorbers and vibration dampers in which the damping force is produced permanently by the magnetic field of the permanent magnets without energy supply.

Due to the brief current in the coil, the magnetisation of the variable permanent magnets can be modified and hence the damping force can be changed permanently.

Further applications are fixing or locking devices. The locking torque or the locking force is thereby produced by the permanent magnets without energy use and eliminated by a brief coil current. For example safety switches can be produced herewith.

Furthermore, the force transmission device according to the invention or the torque transmission device according to the invention can also be used for haptic devices or as man-machine interface. A basic torque which can be perceived clearly by the user or a significantly perceptible basic force is thereby produced by the permanent magnets and can be either reduced or increased by a change in magnetisation of the variable permanent magnets as a result of a brief current in the coil.

The present invention is represented in more detail subsequently in five embodiments: firstly in two torque transmission devices then in a force transmission device, then in a torque- and a force transmission device having a permanent magnet, divided in two, with variable magnetisation.

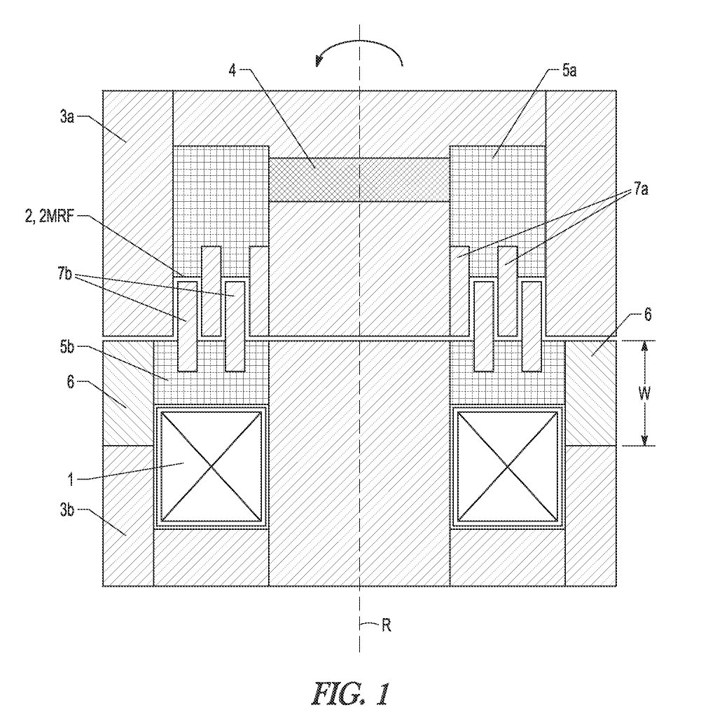

FIG. 1 shows a torque transmission device according to the invention in the form of a magnetorheological coupling in a sectional view.

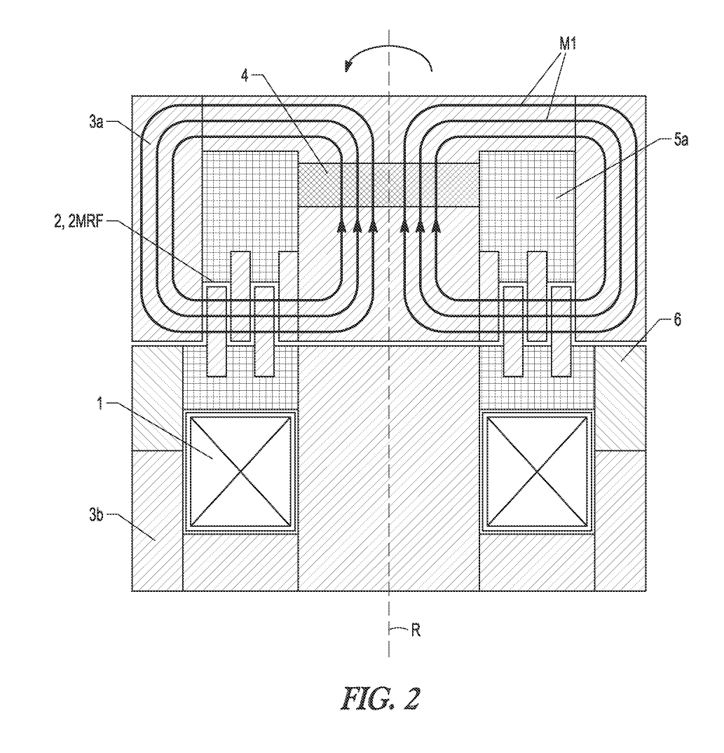

FIG. 2 shows the magnetorheological coupling according to the invention of FIG. 1 with the magnetic field produced by the permanent magnet with non-variable magnetisation.

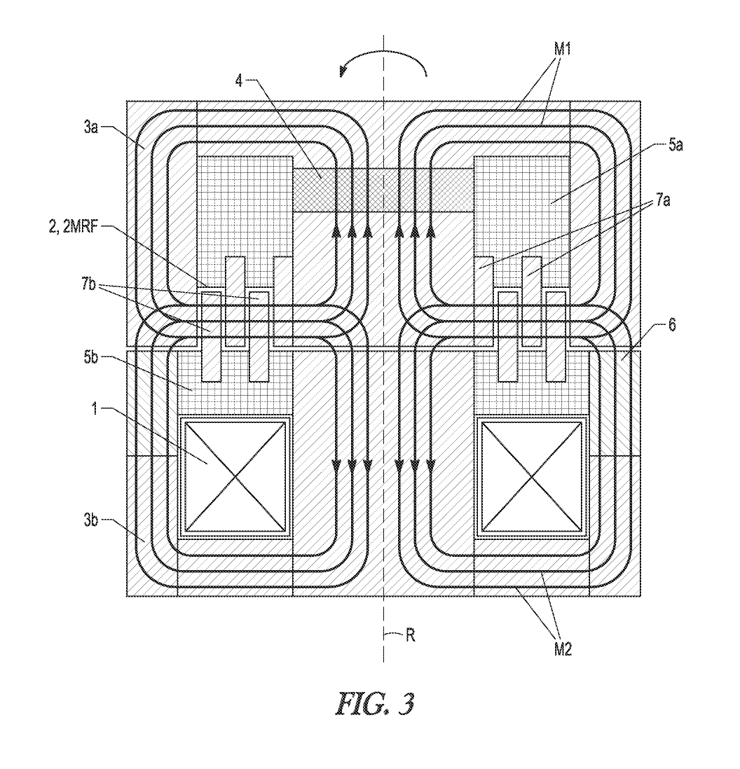

FIG. 3 shows the operation of the magnetorheological coupling according to the invention of FIG. 1 with magnetic field increase by the permanent magnet with variable magnetisation.

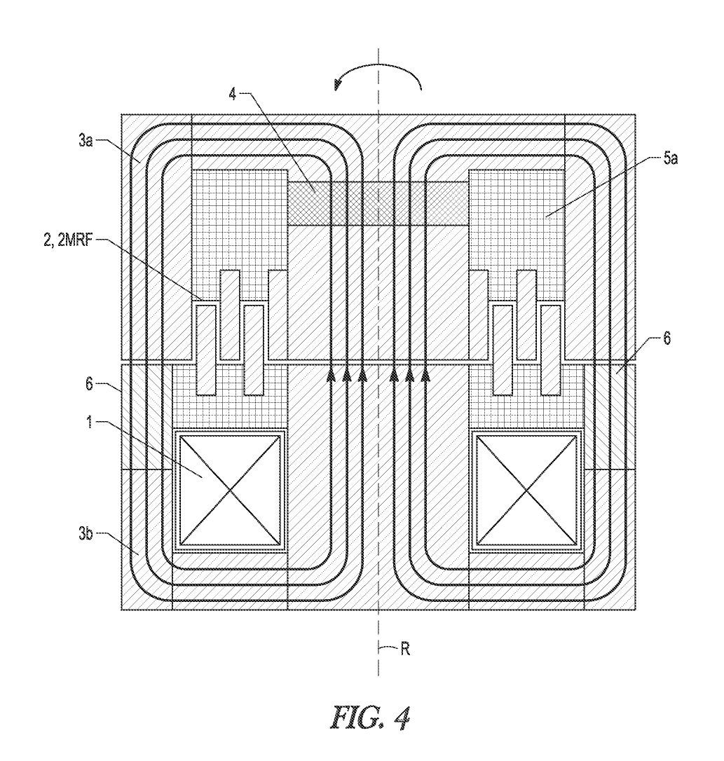

FIG. 4 shows the operation of the magnetorheological coupling according to the invention of FIG. 1 in the state of reduction in flux density by reversal in polarity of the permanent magnet with variable magnetisation.

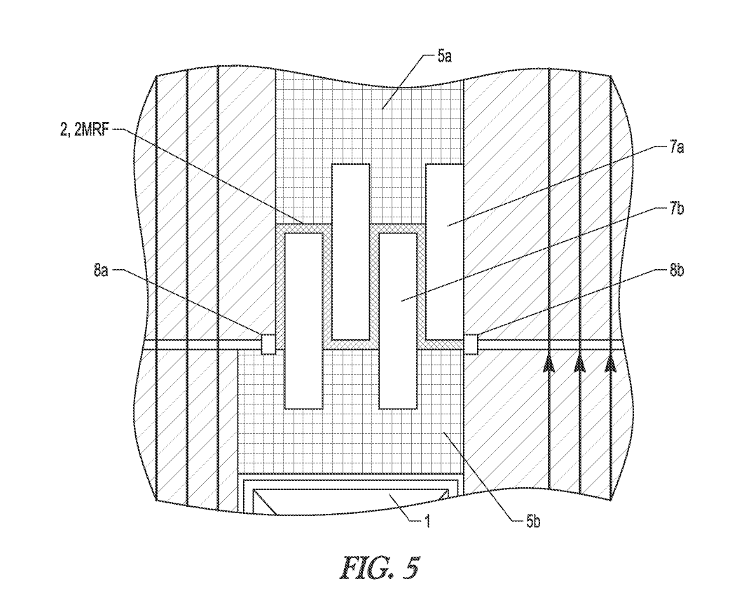

FIG. 5 shows the torque transmission gap of the device according to the invention of FIG. 1 in an enlarged view.

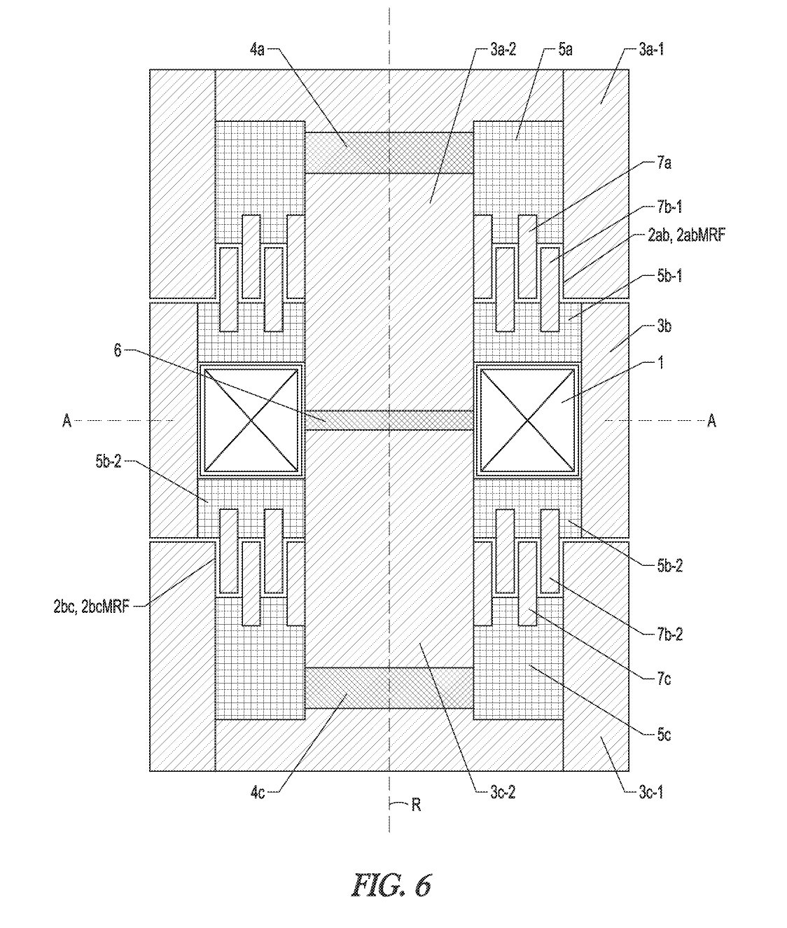

FIG. 6 shows a second torque transmission device according to the invention in the form of a magnetorheological coupling (symmetrical device) in sectional view.

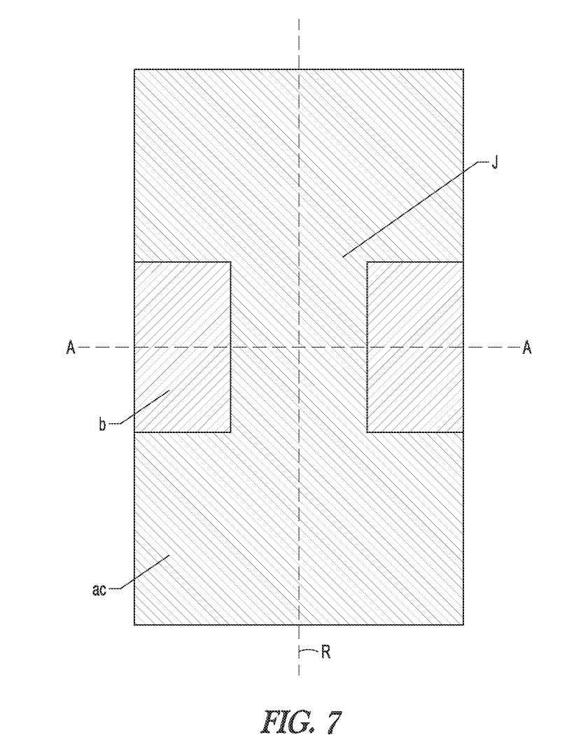

FIG. 7 shows schematically the basic construction of the magnetorheological coupling according to FIG. 6.

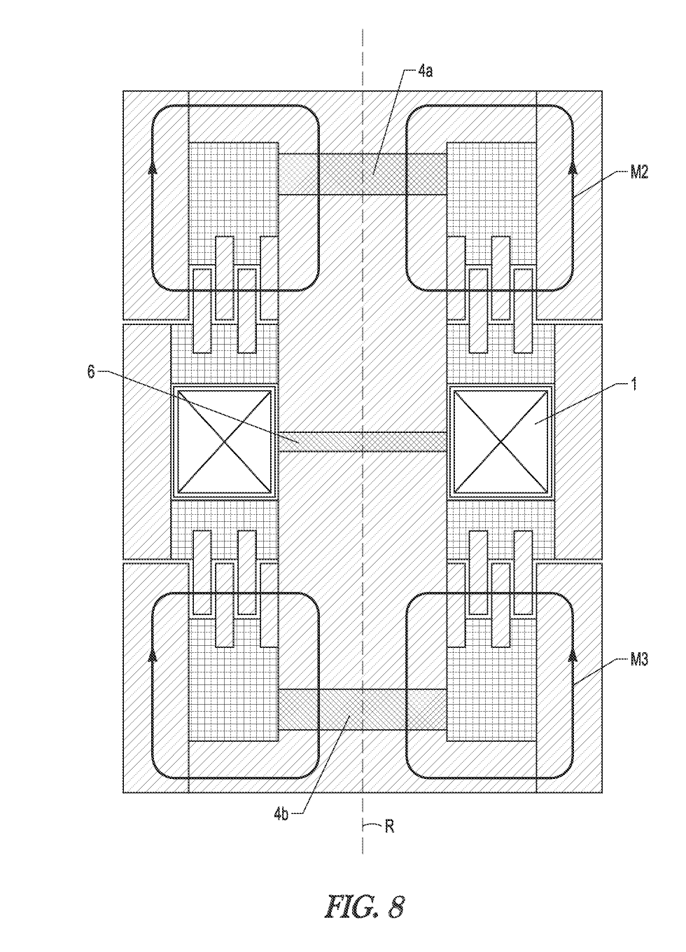

FIG. 8 shows the operation of the magnetorheological coupling according to the invention of FIG. 6 having the magnetic field produced by the permanent magnets with non-variable magnetisation.

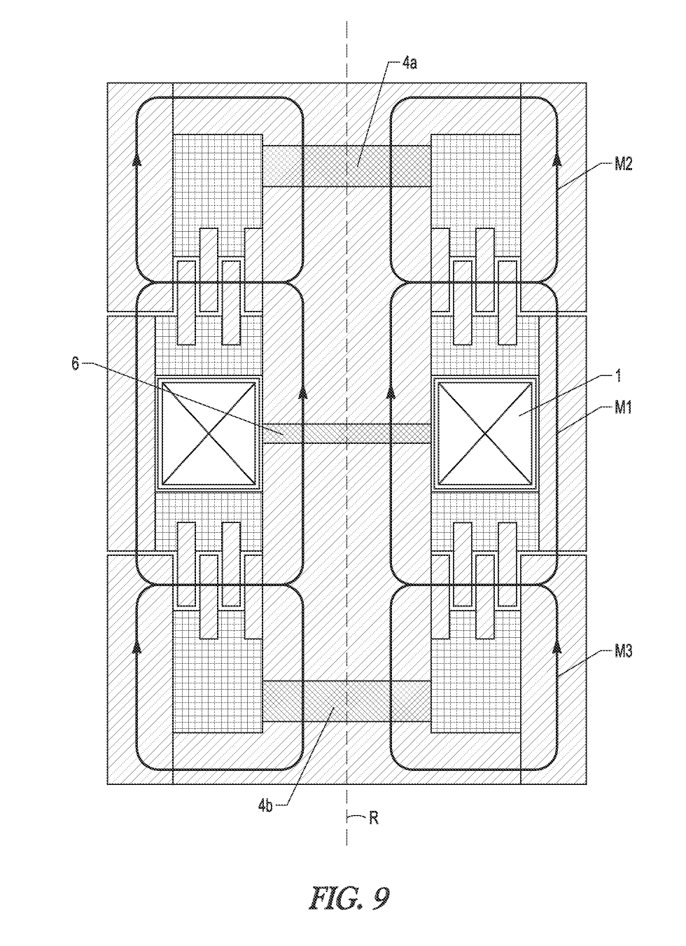

FIG. 9 shows the operation of the magnetorheological coupling according to the invention of FIG. 6 with magnetic field increase by the permanent magnet with variable magnetisation.

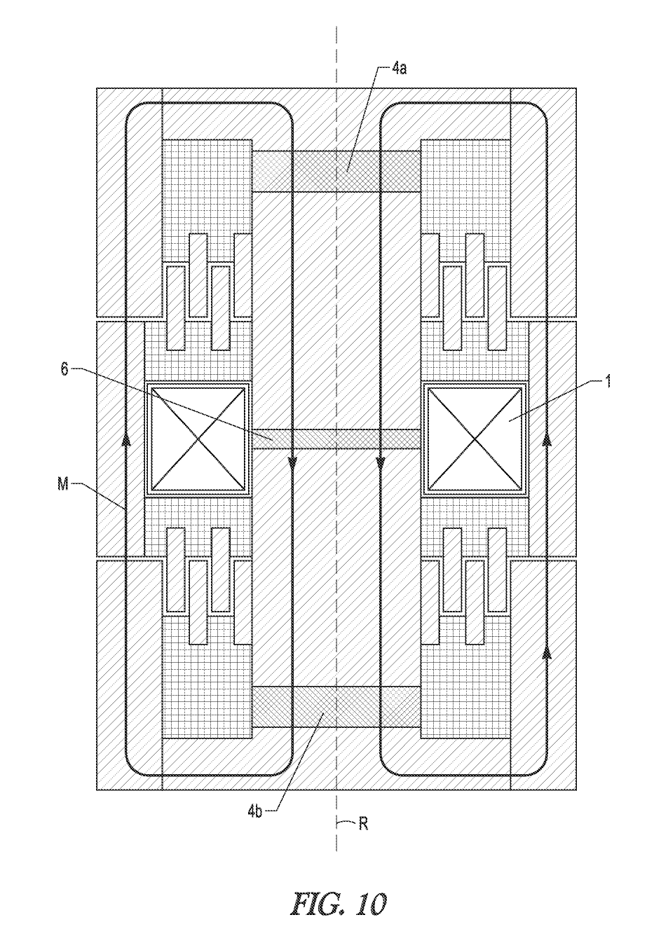

FIG. 10 shows the magnetorheological coupling according to the invention of FIG. 6 in the state of reduction in flux density by reversal of polarity of the permanent magnet with variable magnetisation.

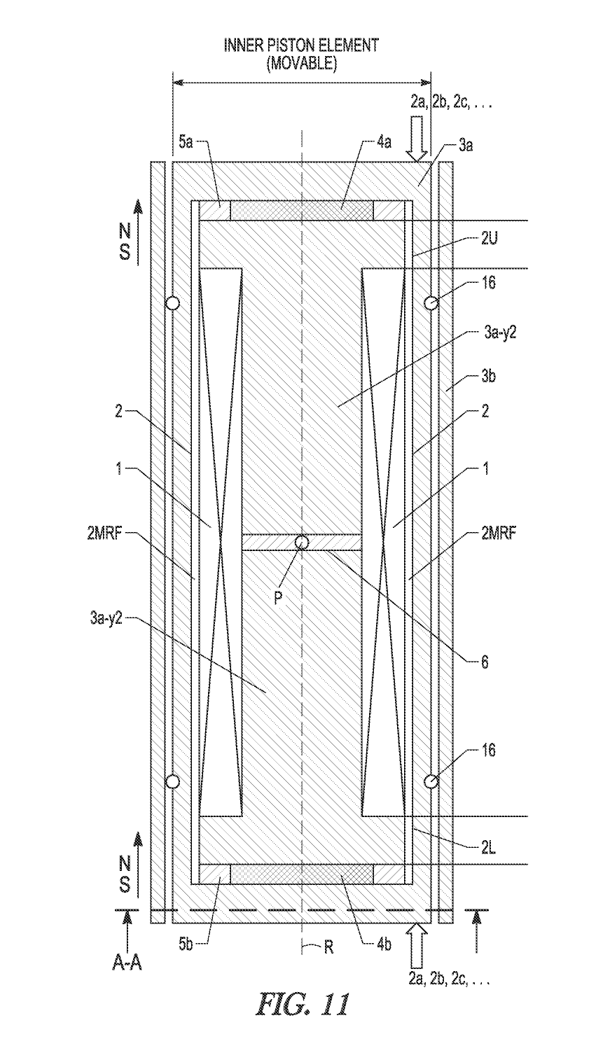

FIGS. 11 to 15 show a force transmission device according to the invention in the form of two piston elements which can be inserted one in the other (magnetorheological damper),

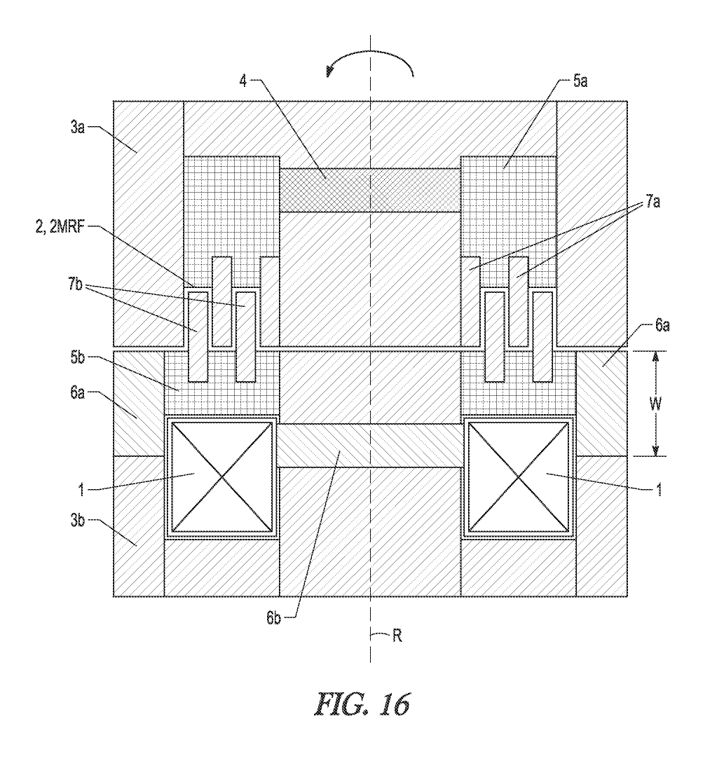

FIG. 16 shows a torque transmission device according to the invention having a permanent magnet, divided in two, with variable magnetisation.

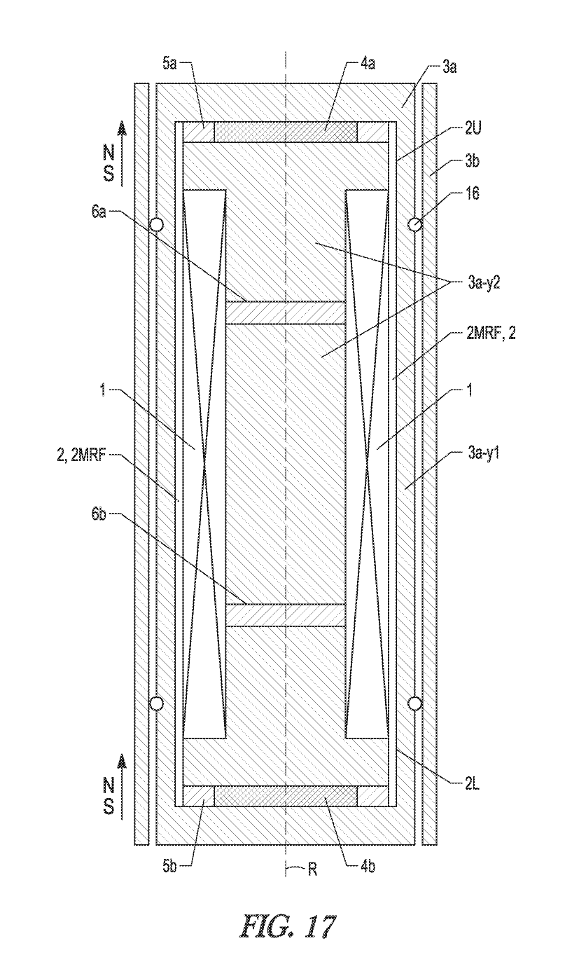

FIG. 17 shows a force transmission device according to the invention, corresponding to that shown in FIGS. 11 to 15, having a permanent magnet, divided in two, with variable magnetisation.

### EMBODIMENT 1

FIG. 1 shows a magnetorheological coupling according to the invention in a sectional view through the axis of rotation R. The illustrated magnetorheological coupling is constructed rotationally-symmetrically about the axis of rotation R. It comprises a first device part or coupling part 3a, 4, 5a, 7a and also a second coupling part 1, 3b, 5b, 6 which is separated therefrom by the torque transmission gap 2 which is filled with an MRF 2MRF. The two coupling parts are constructed as described subsequently in detail. Both coupling parts here are disposed centrically about the axis of rotation and are rotatable mutually or relative to each other about this axis.

The first coupling part comprises a housing 3a made of ferromagnetic material. This housing 3a surrounds the permanent magnet 4 which is disposed centrically on the axis of rotation R. This permanent magnet is configured as a permanent magnet with non-variable magnetisation (this applies subsequently to all permanent magnets with the reference numbers 4, 4a and 4b). The latter is magnetised here in the axial direction or direction of the axis of rotation. The permanent magnet 4 is surrounded radially (i.e. at its outer circumference) by a non-magnetic insert 5a which is likewise surrounded by the housing 3a. The non-magnetic insert 5a is configured here as a three-dimensional, solid moulded body. The non-magnetic insert here consists of an aluminium hollow body filled with air (weight saving) however it can also consist entirely of aluminium, any type of plastic material and/or stainless steel or have these materials or any combinations thereof. In the case of a suitable constructional embodiment (so that for example mounting of the elements 7a is ensured), the insert can also consist entirely of air.

On the side orientated towards second coupling part, a plurality of lamellae made of ferromagnetic material 7a is integrated in the moulded body 5a. These lamellae 7a are configured at a radial spacing from the axis of rotation R and centrically about this, because of the rotational symmetry of the arrangement hence as thin-wall hollow cylinders, the walls of which extend parallel to the axis of rotation R. These lamellae made of ferromagnetic material 7a, together with their counterparts 7b (see subsequently) of the second coupling part, form the MR gap or torque transmission gap 2, which is filled with the magnetorheological fluid 2MRF, between the two coupling parts as result of their zip-like engagement. The torque transmission gap hence extends, viewed in the illustrated section through the axis of rotation, in a meandering shape, the active MR gap portions (i.e. those in which the magnetic field lines enter perpendicularly from the adjacent walls of the ferromagnetic materials 7a, 7b) extending parallel to the axis of rotation R. The magnetorheological coupling is hence configured in a bell configuration or in the axial design.

The second coupling part which is disposed adjacently to the first coupling part on the other side of the MR gap 2 likewise has a housing part 3b made of ferromagnetic material. In this housing part 3b, the coil 1 of the electromagnet is embedded extending radially at a spacing relative to the axis of rotation R. The electromagnet is hence disposed in the form of a hollow cylinder, cuboid in cross-section, the axis of symmetry of which coincides with the axis of rotation. On the side of the second coupling part orientated towards the gap, further non-magnetic moulded bodies 5b made of the same material as the moulded bodies 5a of the first coupling part are disposed abutting against the coil 1. Into these, the above-described lamella counterparts 7b made of ferromagnetic material are embedded. These are configured also like the lamella elements 7a of the first coupling part and disposed such that they engage in the lamella arrangement 7a in the manner of a zip. On the side orientated towards the MRF gap 2, the second coupling part has, on the circumference side, the permanent magnet 6 with variable magnetisation which extends radially at a spacing relative to the axis of rotation R. Subsequently, all permanent magnets which carry the reference number 6 are permanent magnets with variable magnetisation.

This permanent magnet 6 has the width w in the direction of the axis of rotation. The permanent magnet 6 here extends completely closed on the outer circumference side (in the form of a ring) around the second coupling part such that the part, orientated towards the gap 2, of the yoke portion of the housing part 3b, which is situated externally relative to the axis R, is interrupted completely by the permanent magnet 6. By choice of this width w, the adjustment of the operating point of the magnetorheological coupling can be influenced.

The width w adjusts the current-free operating point, i.e. the magnetic field strength of the non-variable permanent magnet 4 which is produced without electrical energy expenditure in the coil. The smaller the width w, the lower the current-free operating point.

At the same time, the width w determines the demagnetisation resistance of the variable permanent magnet 6. The more extended the permanent magnet is, the more difficult it is to be demagnetised.

In the present case, the second coupling part (the one situated at the bottom in the illustrated Figure) represents the drive side. If this rotates, then, with sufficiently high magnetic field strength at which the MRF 2MRF in the gap 2 stiffens, it transmits a torque to the power take-off side (first coupling part). The precise mode of operation of the torque transmission is hereby known to the person skilled in the art. It is likewise known to the person skilled in the art that the illustrated device can also be configured or can be used as a brake. The coupling/brake is hence divided into two parts by the torque transmission gap 2, one part resting (brake) or both parts rotating about the axis of rotation R (coupling) at different speeds, according to the mode of operation.

FIG. 2 now shows the magnetic circuit system of the magnetorheological coupling according to the invention of FIG. 1 in the operating mode, only with the permanent magnet 4 with non-variable magnetisation, i.e. the permanent magnet with variable magnetisation is here unmagnetised and no current flows through the coil. Only in the first magnetic circuit is there a magnetic field in this operating mode (field lines M1). The first magnetic circuit hereby comprises the ferromagnetic housing 3a of the first coupling part, the permanent magnet 4, the lamella arrangement 7 and also the first moulded body 5a surrounded by the magnetic field lines of the permanent magnet or it covers these components with its closed field lines or surrounds them. In the present case, the moulded body 5a is disposed radially on the circumference side of the permanent magnet 4. In an alternative variant, the moulded body 5a and the permanent magnet 4 can however also be configured such that the non-magnetic moulded body is situated in this permanent magnet or surrounded by the latter.

By means of the non-magnetic bell mounting 5a and the variable permanent magnet 6, the magnetic flux 4 produced by the non-variable permanent magnet is conducted perpendicularly through the bells 7a and 7b and hence through the gap 2 filled with 2 MRF. An essential advantage of this arrangement is that, by means of the variable permanent magnet 6, no current, or only very briefly, is required in the coil in order to increase or reduce the magnetic flux produced by the non-variable permanent magnet 4.

A further advantage is that the permanent magnet 4 as a result of the separation of the two magnetic circuits (first magnetic circuit shown here with the magnetic field lines M1, second magnetic circuit see subsequently), is not flowed through counter to its magnetisation direction. The separation of the two magnetic circuits is effected here by the permanent magnet 4, on the one hand, and the coil 1 including permanent magnet 6, on the other hand, being disposed, viewed in the direction of the axis of rotation R, at a spacing relative to each other and in the different coupling parts.

FIG. 3 now shows in addition the second magnetic circuit (magnetic field lines M2) which is formed by the coil 1, the variable permanent magnet 6, the moulded body 5b, the housing portion 3b of the second coupling part and also the lamella arrangements 7a and 7b or which encloses or covers these elements. By switching on the coil current, the permanent magnet 6 with variable magnetisation is magnetised and the magnetic field can be increased in the MRF gap. Care must hereby be taken that the magnetic field has the correct orientation, the current direction for magnetising the variable permanent magnet 6 in the coil 1 is therefore chosen such that, in the region of the torque transmission gap 2, the magnetic field lines M1 of the first magnetic circuit and the magnetic field lines M2 of the second magnetic circuit are superimposed additively. Otherwise, the result is a reduction in flux density in the torque transmission gap 2 (see FIG. 4). The extension w of the permanent magnet 6 should be adjusted such that, with the help of the electromagnet (in the case of the current direction in the electromagnet or in the coil 1 as shown), a magnetisation of the variable permanent magnet 6 by the electromagnet 1 is possible up to the saturation point. At the same time, the width w adjusts the current-free operating point of the variable permanent magnet 6.

FIG. 4 shows the course of the magnetic field lines when the magnetisation of the variable permanent magnet 6 is chosen to be opposite from that shown in FIG. 3 (reversal of polarity of the permanent magnet with variable magnetisation).

FIG. 5 shows a section of the torque transmission gap 2 of FIG. 1 in enlargement. The meandering course, in section, of the torque transmission gap 2 which is produced by the lamella arrangements 7a, 7b of the two coupling parts which engage in each other in the manner of a zip can be readily seen. The torque transmission gap 2 is filled here entirely with the MRF2 MRF (shaded regions). In order to prevent escape of the MRF in the non-operating state and/or in rotation, the torque transmission gap portion filled with the MRF is provided, both on the side orientated towards the axis of rotation R and on the opposite side orientated away, respectively with sealing elements 8a, 8b.

### EMBODIMENT 2

FIG. 6 shows a symmetrically constructed magnetorheological torque transmission device which has an electromagnet, a variable permanent magnet and two non-variable permanent magnets which are disposed concentrically inside the coil of the electromagnet. There is intended here by symmetrically that the illustrated device is not only symmetrical about the axis of rotation R but also mirror-symmetrical relative to the plane A-A which the device intersects perpendicularly to the axis of rotation R at half height.

The first device part (subsequently also termed outer part) is double-T-shaped in the illustrated section (see also FIG. 7) and consists of an upper outer part and a lower outer part. The upper outer part has the elements 3a-1, 3a-2, 4a, 5a, 7a and also the portion of the element 6 situated above the plane A-A, which are described subsequently in more detail. The lower outer part of the outer part has the elements 3c-1, 3c-2, 4c, 5c, 7c and the portion of the element 6 situated below the plane A-A, which are described likewise subsequently in more detail.

In the illustrated case, the outer part represents the power-take-off side, the central part which is described subsequently in more detail is then configured as drive-device part (coupling). However, it is also possible to operate the outer part as drive side and the central part as power-take-off side. In the case of the embodiment as a brake, it is possible to operate the outer part as a device part to be braked (braked to a standstill) and the central part has a part disposed in a stationary manner relative to the surroundings. Also a reversed operation is possible.

As FIG. 7 also shows schematically, the illustrated magnetorheological torque transmission device (coupling or brake) is hence subdivided into two device parts, the outer part ac and the central part b. The central part b is hereby described subsequently in more detail by the MRF gap and possibly further gap portions (in which the two parts b and ac abut against each other in a form fit but are not connected to each other) are separated from the outer part ac and rotatable relative to the latter about the axis of rotation R. The central part b is disposed on the outer circumference side of the yoke portion J of the double-T-shaped outer part at a spacing from the axis of rotation R.

The upper portion of the outer part (or the upper outer part) has a first ferromagnetic housing portion 3a-1 which seals the upper outer part on the outside, just as the housing portion 3a shown in FIG. 1. The non-magnetic insert 5a, the permanent magnet 4a and also the lamella arrangement 7a are disposed therein (as already in the case shown in FIG. 1). The yoke portion J of the upper outer part is configured by a further ferromagnetic housing part 3a-2 which extends along the axis R from the underside of the permanent magnet 4a until abutting against the variable permanent magnet 6. The permanent magnet 6 is disposed mirror-symmetrically relative to the plane A-A, i.e. such that its upper half assigned to the upper outer part is situated above the plane A-A and its lower half assigned to the lower outer part is situated below this plane A-A. The ferromagnetic housing part 3a-2 is hence disposed concentrically about the axis of rotation R inside the non-magnetic insert 5a and the lamella arrangement 7a.

The lower outer part is constructed just as the upper outer part (ferromagnetic housing parts 3c-1 and 3c-2, permanent magnet 4c, non-magnetic insert 5c and also lamella arrangement 7c and lower portion of the element 6), however disposed below the plane A-A mirror-symmetrically to the upper outer part.

The central part which is rotatable relative to the outer part about the axis of rotation R has the housing portion 3b made of a ferromagnetic material, on the outer circumference side, in the form of a hollow cylinder which extends circumferentially at a spacing from the axis of rotation R. Inside this wall portion 3b and outside the yoke portion J of the outer part, the coil 1 of the electromagnet is disposed mirror-symmetrically relative to the plane A-A and hence at the height of the variable permanent magnet 6. Above the coil 1 and hence at a spacing from the plane A-A, the non-magnetic insert 5b-1 in which the lamella arrangement 7b-1 is disposed, is positioned. On the oppositely situated side orientated towards the lower outer part, the non-magnetic insert 5b-2 in which the lamella arrangement 7b-2 is disposed in engagement is accommodated correspondingly at a spacing from the plane A-A. As was already described for FIG. 1, the lamella portions 7b-1 engage in the lamella portions 7a of the upper outer part in the manner of a zip. The same applies to the engagement of the lamella portions 7b-2 in the lamella portions 7c of the lower outer part.

Between the lamella portions 7a and 7b-1, the first torque transmission gap 2ab extends in a meandering shape between the upper outer part and the central part. Likewise, the second torque transmission gap 2bc extends between the lower outer part and the central part in a meandering shape between the lamella arrangements 7b-2 and 7c. The first torque transmission gap is filled with a magnetorheological fluid 2abMRF, the second correspondingly with the MRF 2bcMRF. The two MRF gaps 2ab and 2bc here have a connection (not shown) so that common filling of these gaps with the MRF is possible.

The torque transmission device shown in FIG. 6 hence represents a symmetrically modified version of the torque transmission device shown in FIG. 1. An essential advantage of this arrangement is the double number of MRF gaps (two gaps 2ab and 2bc) and the addition of a further non-variable permanent magnet (two non-variable permanent magnets 4a and 4c) and also the relocation of the variable permanent magnet 6 into the centre of the yoke portion J (viewed relative to the plane A-A). The two non-variable permanent magnets 4 here necessarily have the same axial magnetisation direction (parallel to the direction of the axis of rotation R), directed here for example upwards, i.e. from the lower outer part to the upper outer part. This is necessary since the two permanent magnets 4 would otherwise be mutually weakened. In order that the field line course is possible as desired, the permanent magnet 6 sits between the two permanent magnets 4a and 4b and is thereby disposed, viewed from the axis R, inside the coil 1 (coil inner diameter equal to outer diameter of the permanent magnet 6: the inner yoke portion of the housing 3 is hence interrupted completely and symmetrically by the permanent magnet 6 or divided into the two parts 3a-2 and 3c-2). Viewed in the direction of the axis of rotation R, the following elements are hence disposed along the axis of rotation R and symmetrically about this: permanent magnet 4a, coil 1 including associated variable permanent magnet 6 and permanent magnet 4b. As a result of the thickness of this permanent magnet 6 in the direction of the axis R (i.e. perpendicular to the plane A-A), the magnetic operating point of the torque transmission device can be adjusted in the desired manner.

Only by identical orientation of the magnetic orientation of both permanent magnets 4a, 4c is an increase or complete reduction possible. If the magnetic orientation of both permanent magnets were orientated to be opposite, the magnetic flux density in one gap would be increased, whereas the flux density in the other gap would be reduced.

If the illustrated torque transmission device is configured as a brake, then one of the two device parts is disposed rigidly. Preferably, this is the central part since the coil 1 is thus situated permanently in an unmoving state relative to the surroundings. If the illustrated torque transmission device is configured as a coupling, then a part of the arrangement (preferably the central part) forms the drive side, the other the power take-off side. In both cases, the two device parts can rotate relative to each other about the axis of rotation R.

FIG. 8 shows the torque transmission device of FIG. 6 in the operating mode in which a magnetic flux is produced merely by the two non-variable permanent magnets 4a and 4c: in this case, a first magnetic circuit is configured by the permanent magnet 4a (magnetic field lines M2) via the elements 3a-1, 3a-2, 5a, 7a and 7b-1, which first magnetic circuit produces a magnetic field in the gap 2ab in the magnetorheological fluid 2abMRF. Likewise, a second magnetic circuit (magnetic field lines M3), which comprises the elements 3c-1, 3c-2, 5c, 7b-2 and 7c and forms a magnetic field in the gap 2bc in the MRF 2bcMRF, is configured by the permanent magnet 4c. The illustrated field line direction is produced by both permanent magnets 4 having the same magnetic direction of orientation in order not to be mutually reduced or demagnetised. In contrast to the asymmetrical variant (FIG. 1), the variable permanent magnet 6, viewed relative to the axis R, sits inside the coil 1 and not (like the corresponding air gap 6 in FIG. 1) outside on the coil.

The permanent magnet 6 here is used for the purpose of increasing or reducing the magnetic flux density which is produced by the two non-variable permanent magnets 4a and 4b, by brief magnetisation by the electromagnet. The separation into three magnetic circuits is produced here by the permeability p of the variable permanent magnet 6 being between 1 and 15. Hence, the variable permanent magnet 6 represents a high magnetic resistance. This has the advantage that the magnetic flux is forced by the high magnetic resistance of the variable permanent magnet 6 to be closed over the MRF gap 2ab and 2bc and the bells 7b1, 7b2. Separation of the magnetic circuits has the further advantage that respectively one non-variable permanent magnet 4a or 4c flows through only one bell configuration 7b1 or 7b2.

The magnetic flux density in the MRF gap 2ab and 2bc is consequently higher. The magnetic switching factor of the torque transmission device is consequently likewise increased.

The three permanent magnets 4a, 4c and 6 hence produce a current-free basic torque. For the sake of clarity, the reference numbers of the components have been omitted here in FIG. 8 as also in the two subsequent Figures.

FIG. 9 shows the torque transmission device according to FIG. 6 in the operating mode of increase with permanent magnet 6 fully magnetised by the coil. In this case, a third magnetic circuit (magnetic field lines M1) is configured by the current flow in the coil 1 and the permanent magnet 6, which third magnetic circuit comprises the elements 3b, 5b-1, 5b-2, 3a-2, 3c-2, 7a, 7b-1, 7b-2 and 7c and hence the magnetic field produced by the non-variable permanent magnets 4 in both gaps is superimposed additively. FIG. 9 hence shows the torque transmission device in increasing mode. The magnetic field which is produced by the coil and the magnet 6 is added to the magnetic field present due to the permanent magnets 4. This magnetic field addition functions only when the two permanent magnets 4 have the same magnetic preferential direction, as described above, since otherwise one of these permanent magnets would be increased and the other would be reduced, i.e. a change in the sum would barely be provided. Via the thickness of the permanent magnet 6, the current-free operating point of the two invariable permanent magnets 4a or 4b can be adjusted. A precise design of the central part, in particular relative to the element 6, is therefore essential.

FIG. 10 shows the torque transmission device according to FIG. 6 in the operating mode of reduction: if the magnetic field which is produced by the permanent magnet 6 with variable magnetisation is reversed in polarity, then the magnetic flux (magnetic field lines M) which is produced by the permanent magnets 4a and 4c is pressed out of the MRF gaps 2ab and 2bc. The magnetic flux now closes over the outer yoke (housing parts 3a-1, 3b and 3c-1) of the arrangement. If the magnet 6 in the centre between the coil 1 is designed correctly, then complete compensation of the magnetic flux density, produced by the two invariable permanent magnets 4a and 4b, is possible when the variable permanent magnet 6 is magnetised by the electromagnet up to saturation.

In the now following FIGS. 11 to 15, a magnetorheological force transmission device according to the present invention is described.

FIG. 11 shows a cross-section (through the central longitudinal axis R of the illustrated device) of a magnetorheological force transmission device according to the present invention which represents a damping device.

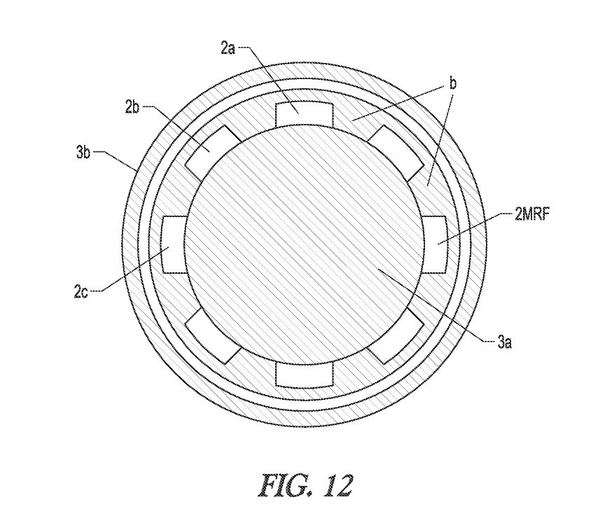

FIG. 12 shows a cross-section through the illustrated device along the direction A-A in FIG. 11, i.e. perpendicular axis of symmetry or longitudinal axis R. The illustrated damping device comprises two piston units inserted one in the other: a first piston unit 3a which is configured essentially in the form of a cylinder and which is insertable into a second piston unit 3b (shown here in inserted state) which is configured as a hollow cylinder into which the first piston unit 3a can be inserted along the longitudinal axis of symmetry R of the illustrated device. Accordingly, the two piston units are configured such that they can be moved relative to each other in a translatory movement along a common axis, the mentioned axis here corresponding to the common longitudinal axis R of the two piston elements. The part 3a is displaceable in a sliding manner correspondingly inside the part 3b. Both parts 3a and 3b are formed by a ferromagnetic material, in this case iron.

On its outer circumference, the inner piston 3a comprises an outer iron yoke part 3a-y1 and its inner portion (i.e. the portion which is disposed inside the outer iron yoke region 3a-y1 in the region of the central axis R and about this central axis R) is configured as inner iron yoke part 3a-y2. The gaps between the part 3a and the part 3b, in an upper portion and in a lower portion, have annular sealing elements 16, the diameter of which corresponds to the outer diameter of the inner piston unit 3a. Accordingly, the parts 3a and 3b are inserted one in the other to form a seal. A force being applied on the inner piston 3a along the direction R, the inner piston 3a is displaced relative to the outer 3b and along the axis R in such a manner as is described later in more detail (i.e. in a manner which depends upon the rigidity of the magnetorheological material 2MRF).

Viewed along the central axis R, the inner piston 3a comprises three different portions or regions in which three different separate magnetic circuits are configured (see subsequently): in a first, central portion along the axis R, a permanent magnet with variable magnetisation (permanent magnet 6) is configured in the inner iron yoke part 3a-y2. This is configured here in the form of a flat disc which is disposed perpendicular to the axis R. On the outer circumference of this permanent magnet disc 6, the coil of the electromagnet 1 is disposed. Accordingly, the inner radius of the hollow cylindrical electromagnet 1 (the axis of symmetry of the hollow cylinder corresponds thereby to the axis R) corresponds to the outer radius of the disc of the variable permanent magnet 6 so that the inner yoke part 3a-y2, viewed along the axis R, is separated completely by the permanent magnet 6 in a symmetrical manner into an upper part and into a lower part. This complete separation of the inner yoke part 3a-y2 is an essential aspect of the present invention since, because of this separation and the arrangement of the permanent magnet 6, the magnetic flux lines extend as follows:

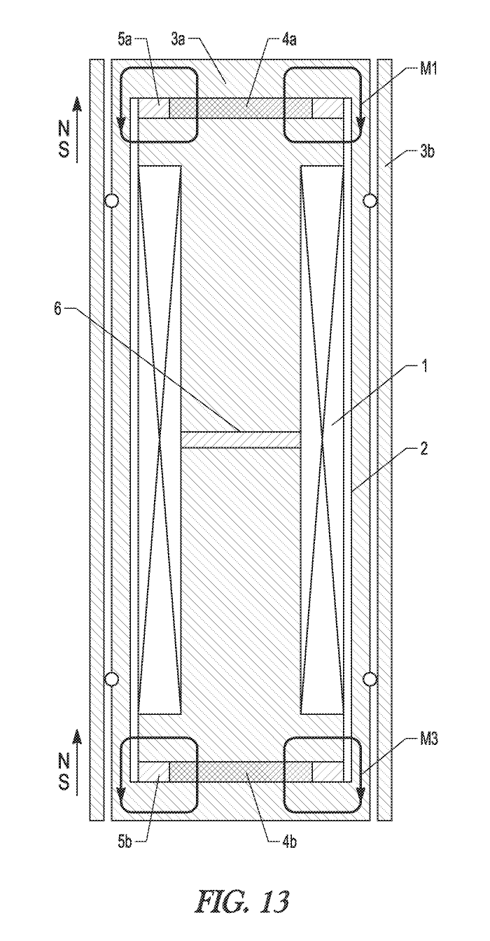

The flux lines of the magnetic circuit M1 and M3, starting from the permanent magnet 4a or 4b, extend over the yoke parts 3a and 3a-y1, over the MRF gap 2U or 2L and are closed hence over the yoke part 3a-y2. Because of the high magnetic resistance of the variable permanent magnet 6, the magnetic flux, caused by the invariable permanent magnets 4a or 4b, is not closed briefly and formation of a magnetic circuit, as in FIG. 13, results.

The magnetic circuit M2 is formed, starting from the invariable permanent magnet 6 over the yoke part 3a-y2, over the MRF gaps 2U and 2L, over the yoke part 2a-y1, and closes again over the yoke 3a-y2 towards the invariable permanent magnet 6.

Accordingly, the arrangement of the permanent magnet 6 here is such that the magnetic flux lines of the two outer, non-variable permanent magnets 4a and 4b (see subsequent description) are not short-circuited.

As an alternative thereto, instead of the arrangement of a disc-shaped variable permanent magnet 6 which separates the inner yoke part 3a-y2 an annular variable permanent magnet (not shown) can be disposed, which completely divides the outer yoke part 3a-y1, viewed along the axis R, into symmetrical parts. Such an arrangement also produces complete separation. The ferromagnetic part of the damper needs to be interrupted only once in order to produce this separation.

Accordingly, at least one variable permanent magnet 6 is disposed either centrically (and preferably in the form of a disc) on the axis R or is disposed concentrically, preferably in the form of a flat hollow cylinder, a toroid or a ring, about this axis.

Viewed along the axis R, two non-variable permanent magnets 4a and 4b are disposed on both sides of the central electromagnet 1: a first permanent magnet 4a with non-variable magnetisation in the form of a flat disc which is disposed in the upper portion of the piston 3a, close to the upper end of the mentioned piston, this disc being disposed centred about the axis R and perpendicular to this axis, and a second permanent magnet 4b with non-variable magnetisation which is formed like the first permanent magnet 4a and is disposed perpendicular to the axis R on the lower end portion of the piston 3a. Each of the permanent magnets 4a and 4b is surrounded by a non-magnetic insert which is formed from aluminium (flat annular disc or hollow cylinder 5a and 5b). Each of these non-magnetic inserts 5a and 5b is configured as a flat ring, the inner diameter of which corresponds to the outer diameter of the associated permanent magnet 4a or 4b. Each permanent magnet 4a, 4b (viewed along the axis R) is disposed at the same height, like its associated non-magnetic insert 5a, 5b. The permanent magnets 4a, 4b are formed here from NdFeB. Both permanent magnets 4a, 4b are disposed such that their magnetic flux lines are formed parallel to each other (i.e. identical arrangement of their corresponding north-south orientation NS).

The illustrated inner piston 3a is provided with an MRF gap 2 which is situated along the entire circumference of the inner piston 3a at a radial spacing from the axis R which corresponds approximately to the outer diameter of the non-magnetic inserts 5a and 5b or to the outer diameter of the hollow cylindrical electromagnet 1. The MRF gap 2 extends almost along the entire length of the inner piston 3a (viewed in the direction of the axis R) with the exception of the upper end portion and of the lower end portion of the inner piston (these portions are those which, viewed from the central point P of the symmetrical arrangement, extend above the elements 4a/5a and below the elements 4b/5b). In these outer portions, the piston 3a, see FIG. 12, is provided with a plurality of outlets 2a, 2b, 2c . . . which are connected to the MRF gap 2 or configured as part of the latter and are disposed over the entire circumference of the piston 3a at a spacing from the axis R which corresponds approximately to the spacing of the MRF gap 2 of the mentioned axis R. Accordingly, the outlets 2a, 2b, 2c . . . and the MRF gap 2 are disposed along the axis R such that a magnetorheological fluid 2MRF can flow through the channels 2, 2a, 2b, 2c . . . along the axis R. The MRF gap 2 is disposed essentially parallel to the common longitudinal axis of the two piston units 3a, 3b.

The non-magnetic inserts 5a, 5b are used for the purpose of increasing the magnetic field produced by the permanent magnets with non-variable magnetisation 4a, 4b in the region of the magnetorheological “valves” 2U or 2L. They are configured preferably to be as large as possible in order to assist the formation of the magnetic field by the non-variable permanent magnets 4a, 4b and in order to prevent a magnetic short circuit of the field lines of these magnets. Because of the illustrated symmetrical arrangement, assuming that the length of the valves 2U/2L is the same, the coil field of the electromagnet 1 is not modified by the design of the non-magnetic inserts 5a, 5b.

The shape and the arrangement of the permanent magnet 6 with variable magnetisation is a compromise and achieves the idea of the present invention: for a given number of coil windings in the coil of the electromagnet 1,
an increase in the thickness of the permanent magnet 6 (viewed in the direction of the axis R) has the effect that the magnetic resistance of the magnetic circuit M2 and hence the flux density produced by the permanent magnets 4a and 4b with invariable magnetisation in the MRF gap 2L or 2U increases.
a reduction in the thickness of the permanent magnet 6, viewed along the axis R, has the effect that the magnetic resistance of the magnetic circuit M2 and hence the flux density produced by the permanent magnets 4a and 4b with invariable magnetisation in the gap 2L or 2U is reduced.
General explanation in this respect: the variable permanent magnet 6 represents a high magnetic resistance in the magnetic circuit M2 with its low permeability. As a result, the separation in 3 magnetic circuits is achieved.

As is evident from FIG. 11, the magnetorheological force transmission device is, relative to a plane through the point P perpendicular to the axis R, a mirror-symmetrical arrangement and, with respect to the axis R, almost a rotationally-symmetrical arrangement about the axis R (rotationally-symmetrical with the exception of the elements 2a, 2b, 2c . . . ).

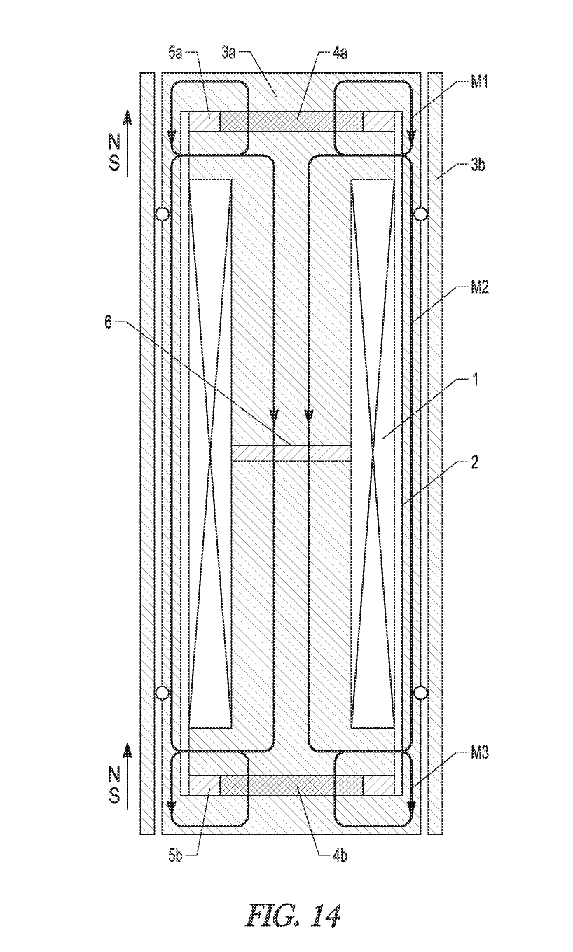

If accordingly the channel portions 2, 2a, 2b, 2c . . . are filled with the magnetorheological fluid 2MRF, the arrangement of the upper non-variable permanent magnet 4a, together with its associated non-magnetic insert 5a and together with the corresponding upper active MRF gap part 2U, forms a first, upper MRF valve, whereas the arrangement of the elements 4b, 5b, situated at the bottom, together with the corresponding lower, active part 2L of the MRF gap, forms a second MRF valve situated at the bottom. Accordingly, the result, because of the magnetic flux in these valves which is formed by the permanent magnets 4, is a specific basic stiffening of the MRF in the corresponding portions 2U, 2L of the MRF gap 2, which results in a basic damping of the illustrated arrangement also in the case where no current flows through the coil of the electromagnet 1. If the current direction through the coil of the electromagnet 1 is chosen correspondingly, then the magnetic flux through the active parts 2U, 2L of the MRF gap 2 can be increased by increasing this current, as a result of which the damping of the entire arrangement is increased (see FIG. 14).

As is evident from FIGS. 13 to 15, all the magnetic circuits produced are formed in the moveable inner piston 3a (at most three magnetic circuits are formed by the two permanent magnets 4 with non-variable magnetisation, the electromagnet 1 and the permanent magnet 6 with variable magnetisation (cf. FIG. 14). The outer piston 3b (outer casing) serves merely as housing and as guide for the inner piston 3a. The outlets 2a, 2b, 2c . . . are formed as hollowed-out portions or notches in the upper or the lower yoke portion of the piston 3a. Because of this shaping, the magnetic circuit is scarcely interrupted and the magnetic flux is compressed only by the beams b which are formed between two adjacent notches 2a, 2b . . . .

If the inner piston 3a is moved upwards or downwards along the axis R, MRF flows through the inlets/outlets 2a, 2b, 2c . . . through both MRF valves and from the upper side to the lower side or from the lower side to the upper side of the inner piston 3a and hence flows through the mentioned piston. It is ensured by the illustrated geometry that the inlets/outlets are practically free of a magnetic field (the flux of the MRF current is extended by increasing the diameter of the MRF gap 2 along the extension of the electromagnet 1 in order to achieve a higher switching factor between magnetorheological and fluid-hydraulic pressure loss (ratio of pressure losses with and without the magnetic field)). The inner piston unit 3a is sealed against the outer casing with seals 16 which are known from the state of the art so that a bypass gap a in the ₚresent case is prevented.

It is important that the two permanent magnets 4a and 4b with non-variable magnetisation have the same magnetic orientation N-S. Otherwise, in the case of magnetisation of the variable permanent magnet 6 (current flows briefly in the coil), the magnetic flux would be increased in one active MRF gap (for example 2U), whereas the magnetic flux in the other active MRF gap (for example 2L) would be reduced so that essentially no change in the flux resistance would result for the MRF 2MRF.

By the permanent magnets 4 and the permanent magnet 6 being used as described above, it is possible to produce a variably preselectable, basic shear resistance of the MRF without expenditure of electrical energy by the electromagnet.

By using the electromagnet and/or by adjusting the permanent magnet 6 with variable magnetisation, it is possible to reduce the magnetic fields of the permanent magnets 4a, 4b with non-variable magnetisation down to almost zero so that, in the extreme case, only the fluid-hydraulic properties of the MRF without magnetic field become relevant. On the other hand, it is also possible to increase the field of the permanent magnets 4a, 4b with non-variable magnetisation in this way such that very high shear resistance values can be achieved. Because of the basic shear resistance adjusted by the permanent magnets 4 and 6, a desired fail-safe behaviour of the illustrated device can be ensured.

FIG. 13 shows the first magnetic circuit (magnetic flux lines M1) of the above-described system which comprises the permanent magnet 4a with non-variable magnetisation, the non-magnetic insert 5a, that part of the MRF gap 2 which corresponds to the upper magnetic valve 2U, and the parts of the inner yoke part 3a-y2, of the outer yoke part 3a-y1 and also of the upper cover of the inner piston 3a which surround the elements 4a, 5a. Likewise, the third magnetic circuit (magnetic flux lines M3) is shown, which comprises the corresponding parts at the lower end of the piston 1a: elements 4b, 5b just as the parts of the elements 3a-y2, 3a-y1 and of the lower cover of the piston 3a which surrounds the elements 4b, 5b.

As seen in FIG. 13, the two non-variable permanent magnets 4a, 4b close their magnetic flux lines exclusively through the MRF gap 2 (in the region of the active parts 2U, 2L).

In addition to the first and third magnetic circuit M1, M3, as are shown in FIG. 13, FIG. 14 also shows the central magnetic circuit, the second magnetic circuit (magnetic flux lines M2), which comprises the electromagnet 1, the permanent magnet 6 with variable magnetisation and those parts of the inner iron yoke portion 3a-y2, of the outer yoke portion 3a-y1 and of the MRF gap 2 which surround these elements 1 and 6. In FIG. 14, the current which flows through the electromagnet or the coil thereof is selected such that the variable permanent magnet 6 is adjusted, by a brief current surge, to a magnetisation which increases the magnetic flux density to the maximum, produced by the non-variable permanent magnets 4a and 4b. The increase is adjusted by the current strength in the coil. A maximum magnetisation is achieved upon reaching the material constant Br (saturation magnetisation) of the variable permanent magnet 6.

In contrast thereto, the current direction in the electromagnet 1 is reversed so that a magnetisation which is opposite to the magnetic flux, produced by the non-variable permanent magnets 4a and 4b, results. In the case of demagnetisation or remagnetisation of the variable permanent magnet 6, the flow in the electromagnet 1 must be so high that the material constant −ⱼH_{c} of the variable permanent magnet 6 is exceeded.

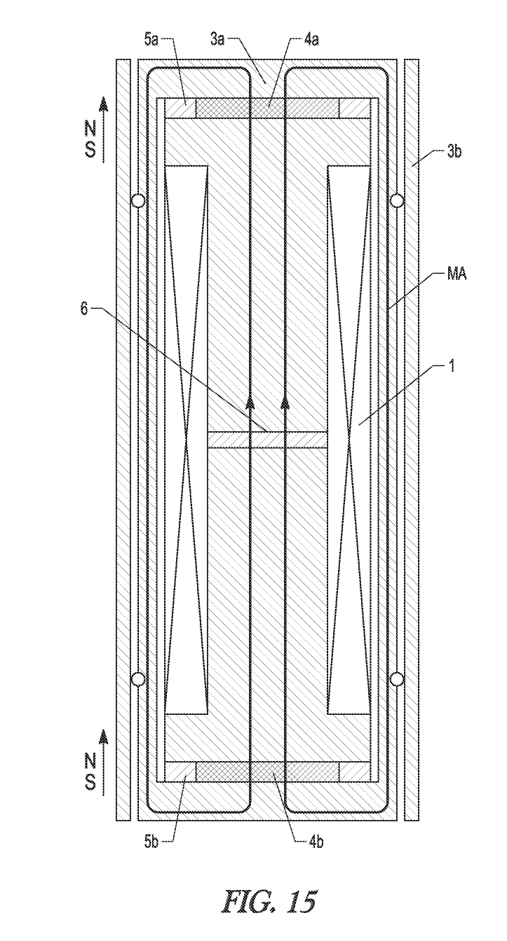

With the help of the non-magnetic inserts 5a, 5b which are configured on the outer circumference of the permanent magnets 4a, 4b with non-variable magnetisation, almost complete compensation of the magnetic field within the MRF valves 2U/2L is possible since the magnetic flux within the MRF valves is distributed in an almost homogeneous manner. Thus in the reduction state which is shown in FIG. 15, almost no magnetic flux remains within the MRF gap 2 which comprises the active MRF gaps 2U or 2L, and the magnetic field of the permanent magnets 4 with non-variable magnetisation can be almost completely compensated for and in a homogeneous manner.

Subsequently, also two embodiments (torque transmission device, FIG. 16 and force transmission device, FIG. 17) are described, in which two permanent magnets with variable magnetisation 6a, 6b or a permanent magnet 6a, 6b, divided in two, with variable magnetisation is provided, the two magnets or magnet parts being connected by a magnetically conductive material.

The embodiments with two permanent magnets 6a, 6b with variable magnetisation have the advantage that a more homogeneous flux density distribution in the magnet yoke can take place. Hence, the result is reduced saturation effects in the yoke and the magnetic material present can be used more efficiently for flux guidance.

At the same time, great influence can be had thus upon the magnetic field strength, produced by the two variable permanent magnets 6a, 6b. If in fact such a division in two is provided, then the volume is consequently increased, hence a higher flux density can be produced in the MRF gap by a higher total residual flux density and/or a plurality of MRF gaps can be flowed through by magnetic field lines.

FIG. 16 shows a further magnetorheological torque transmission device according to the invention in a sectional view through the axis of rotation R. This torque transmission device is basically constructed like the torque transmission device shown in FIG. 1 so that only the differences are subsequently described: in addition to the permanent magnet 6 with variable magnetisation shown in FIG. 1 (which bears the reference number 6a here), an additional permanent magnet part 6b with variable magnetisation is disposed in the second, lower device part concentrically within the electromagnet 1. This part 6b is configured as a flat circular disc with the same dimensions as the permanent magnet 4 with non-variable magnetisation and is disposed concentrically about the axis of rotation R. Its (viewed perpendicular to the axis of rotation R) outer edge is flush with the inner wall of the coil 1 of the electromagnet so that the outer diameter of the permanent magnet part 6b corresponds to the inner diameter of the coil 1. The inner yoke of the second device part is hence divided into two parts by the permanent magnet part 6b, viewed in the direction of the axis of rotation R. The permanent magnet part 6a sitting externally and the permanent magnet part 6b sitting internally are coupled to each other magnetically via a portion of the ferromagnetic housing part 3b.

FIG. 16 hence shows a modification of the first embodiment in which a division of the variable permanent magnet 6 into two parts is provided. Basically, the permanent magnet 6 can also be separated into more than two parts which are respectively coupled to each other magnetically via magnetically conducting material. The division of the variable permanent magnet 6 is effected here hence in a first part (annular part 6a) and in a second part (disc-shaped part 6b), the latter sitting in the central yoke in the housing portion 3b. Both variable permanent magnets 6a, 6b are connected via the magnetically conducting material of the housing portion 3b. The magnetic circuit configuration does not differ from that shown in the first embodiment.

FIG. 17 shows a further embodiment of a force transmission device according to the invention. The basic construction here is like the force transmission device shown in FIGS. 11 to 15 so that only the differences are subsequently described.

Instead of the individual permanent magnet 6 with variable magnetisation which is shown in FIGS. 11 to 15 and is disposed (viewed along the axis of rotation R) such that the inner iron yoke part 3a-y2 is divided completely into two symmetrical parts, now two separated permanent magnet parts 6a, 6b with variable magnetisation are provided here, which completely separate the inner iron yoke part 3a-y2 of the inner piston 3a into three parts which are completely separated from each other. Here also, the outer diameter of the parts 6a, 6b configured as circular discs corresponds hence to the inner diameter of the electromagnet 1. Both parts 6a, 6b are hence displaced, relative to the individual magnet 6 shown in FIGS. 11 to 15, along the axis of rotation R from the centre of the arrangement outwards by respectively the same distance portion so that the inner iron yoke portion 3a-y2 here is divided completely into three parts.

FIG. 17 hence shows a modification of the embodiment shown in FIGS. 11 to 15, which provides a division of the variable permanent magnet 6 into two parts 6a, 6b. The parts 6a, 6b are connected to each other via the magnetically readily conducting material of the centrally disposed part of the three parts of the inner yoke part 3a-y2 and hence are integrated optimally in the inner yoke 3a-y2. The magnetic circuit configuration does not differ from that shown in the embodiment of FIGS. 11 to 15.

What is claimed is:

1. A magnetorheological torque transmission device comprising at least two device parts which are separated by at least one transmission gap for torque transmission which can be filled at least partially with a magnetorheological material and are rotatable relative to each other about an axis of rotation,
wherein a magnetic circuit system of the torque transmission device, which is configured to produce a magnetic flux in at least one part of the transmission gap, comprises, in addition to at least one electromagnet, at least one permanent magnet with variable magnetisation, the electromagnet and the permanent magnet being configured and disposed such that the magnetisation of the permanent magnet can be adjusted by changing the coil current of the electromagnet.

2. A magnetorheological force transmission device comprising
at least two device parts which can be moved in an essentially translatory manner relative to each other, and
at least one transmission gap for force transmission which can be filled at least partially with a magnetorheological material, and is disposed at least partially in one of the device parts, at least partially in both device parts or at least partially between both device parts,
wherein a the magnetic circuit system of the force transmission device, which is configured to produce a magnetic flux in at least one part of the transmission gap, comprises, in addition to at least one electromagnet, at least one permanent magnet with variable magnetisation, the electromagnet and the permanent magnet being configured and disposed such that the magnetisation of the permanent magnet can be adjusted by changing the coil current of the electromagnet.

3. The magnetorheological transmission device according to claim 1, wherein the magnetic circuit system of the transmission device, which is configured to produce the magnetic flux in at least one part of the transmission gap, comprises, in addition to at least one electromagnet, at least two permanent magnets with variable magnetisation which are coupled to each other magnetically via a magnetically conducting material, the electromagnet and these two permanent magnets being configured and disposed such that the magnetisation of these two permanent magnets can be adjusted by changing the coil current of the electromagnet.

4. The magnetorheological transmission device according to claim 1, wherein the permanent magnet with variable magnetisation comprises a material or consists thereof, the coercive field strength ⱼH_{c} of which is between 5 and 300 kA/m, and/or in that the permanent magnet with variable magnetisation comprises at least one of the following magnetic materials and/or consists thereof: an alloy comprising Al, Ni and Co (AlNiCo) and/or ferrites, in particular made of barium or strontium oxide with iron oxide.

5. The magnetorheological transmission device according to claim 1, wherein the magnetic circuit system of the transmission device comprises in addition at least one further permanent magnet with non-variable magnetisation.

6. The magnetorheological transmission device according to claim 5, wherein the permanent magnet with non-variable magnetisation comprises a material or consists thereof, the coercive field strength ⱼH_{c} of which is greater than 300 kA/m, and/or in that the permanent magnet with non-variable magnetisation comprises at least one of the following hard magnetic materials and/or consists thereof: an alloy comprising Sm and Co, in particular SmCo₅ or Sm₂Co₁₇, and/or an alloy comprising Nd, Fe and B (NdFeB).

7. The magnetorheological transmission device according to claim 5, wherein the permanent magnet with non-variable magnetisation comprises a material or consists thereof, the coercive field strength ⱼH_{c} of which is greater by at least the factor 2, than that of the material which the permanent magnets with variable magnetisation comprises or consists of.

8. The magnetorheological transmission device according to claim 1, wherein the magnetic circuit system of the transmission device comprises furthermore at least one non-magnetic insert in the form of a magnetic field-regulating insert and/or a magnetic insulator.

9. The magnetorheological transmission device according to claim 8, wherein the magnetic insulator is a three-dimensional solid body made of at least one non-magnetic material with a relative permeability of less than 2, and/or in that the magnetic field-regulating insert is a three-dimensional solid body with a relative permeability of greater than or equal to 2 and less than or equal to 10, and/or characterised by an air-filled volume as non-magnetic insert.

10. The magnetorheological transmission device according to claim 5, wherein the magnetic circuit system of the transmission device has at least a first magnetic circuit and a second magnetic circuit, the electromagnet and the permanent magnet with variable magnetisation being configured and disposed such that they belong to the second magnetic circuit and the permanent magnet with non-variable magnetisation being configured and disposed such that it belongs to the first magnetic circuit.

11. The magnetorheological transmission device according to claim 10, wherein the magnetic flux of the first and of the second magnetic circuit of the magnetic circuit system of the transmission device is superimposed in at least one part of the at least one transmission gap.

12. The magnetorheological transmission device according to claim 10, wherein at least one non-magnetic insert in the second magnetic circuit and/or in the first magnetic circuit.

13. The magnetorheological transmission device according to claim 10, wherein the electromagnet, the permanent magnet with non-variable magnetisation and the permanent magnet with variable magnetisation and at least one non-magnetic insert are configured and positioned spatially such that the second magnetic flux which is produced by the electromagnet and the permanent magnet with variable magnetisation leads through the second magnetic circuit and preferably not through the permanent magnet with non-variable magnetisation, and in that the first magnetic flux which is produced by the permanent magnet with non-variable magnetisation leads through the first magnetic circuit, the first and the second magnetic flux leading at least through one part of the transmission gap.

14. The magnetorheological transmission device according to claim 1, wherein the magnetic circuit system of the transmission device comprises at least one electromagnet, two permanent magnets with non-variable magnetisation, a permanent magnet with variable magnetisation and two transmission gaps.

15. The magnetorheological transmission device according to claim 14, wherein an arrangement along an axis, preferably a symmetrical arrangement along the axis, in which the electromagnet, together with the permanent magnet with variable magnetisation which is disposed concentrically inside the coil of this electromagnet is disposed between the two permanent magnets with non-variable magnetisation, three magnetic circuits being able to be configured or being configured in the magnetic circuit system of the transmission device including a first magnetic circuit to which the first permanent magnet with non-variable magnetisation belongs, a third magnetic circuit to which the second permanent magnet with non-variable magnetisation belongs and a second magnetic circuit situated between the first and the third magnetic circuit, to which the electromagnet and the permanent magnet with variable magnetisation belong.

16. The magnetorheological transmission device according to claim 14, wherein the electromagnet, the two permanent magnets with non-variable magnetisation, the permanent magnet with variable magnetisation and the two transmission gaps and at least one non-magnetic insert are configured and positioned spatially such that that the magnetic flux which is produced by the electromagnet and the permanent magnet with variable magnetisation leads through both transmission gaps, but not through any of the permanent magnets with non-variable magnetisation, and/or in that the magnetic flux which is produced respectively by one of the two permanent magnets with non-variable magnetisation leads only through one of the two transmission gaps.

17. The magnetorheological transmission device according to claim 1, wherein a plurality of transmission gaps are disposed essentially parallel to each other and have a connection to each other for the magnetorheological material.

18. The magnetorheological transmission device according to claim 1, wherein the magnetic circuit system of the transmission device comprises 2S-1 electromagnets having respectively at least one assigned permanent magnet with variable magnetisation (with S=1, 2, 3 . . . ) and 2P permanent magnets with non-variable magnetisation (P=1, 2, 3 . . . ) per electromagnet, preferably there applying P=S.

19. The magnetorheological transmission device according to claim 5, wherein a non-magnetic insert in the form of a magnetic insulator which is disposed in, on and/or about the permanent magnet with non-variable magnetisation, concentrically about the permanent magnet with non-variable magnetisation.

20. The magnetorheological transmission device according to claim 1, wherein the magnetorheological material comprises at least one of a magnetorheological fluid, a magnetorheological gel, a magnetorheological elastomer or a magnetorheological foam.

21. The magnetorheological torque transmission device according to claim 1, wherein the permanent magnet with non-variable magnetisation and the electromagnet are disposed, viewed in the direction of the axis of rotation, at a spacing from each other.

22. The magnetorheological torque transmission device according to claim 15, wherein the electromagnet together with the permanent magnet with variable magnetisation and the two permanent magnets with non-variable magnetisation are disposed along the axis of rotation and are rotationally-symmetrical about the axis of rotation.

23. The magnetorheological torque transmission device according to claim 1, wherein the electromagnet, the permanent magnet with variable magnetisation and/or a permanent magnet with non-variable magnetisation is/are disposed either centrically on the axis of rotation or at a radial spacing from and radially-symmetrical about the axis of rotation.

24. The magnetorheological torque transmission device according to claim 1, wherein at least one of the transmission gaps is disposed essentially parallel to the axis of rotation or essentially perpendicular to the axis of rotation.

25. The magnetorheological torque transmission device according to claim 1, wherein the configuration as coupling, brake, dynamic damper, fixing or locking device, safety switch, haptic device or as man-machine interface element.

26. The magnetorheological force transmission device according to claim 2, wherein the electromagnet, a permanent magnet with non-variable magnetisation, the permanent magnet with variable magnetisation, a non-magnetic insert and/or the transmission gap are disposed at least partially inside one of the device parts and/or at least partially abutting against one of the device parts.

27. The magnetorheological force transmission device according to claim 2, wherein the two device parts comprise or consist of two piston elements which can be pushed one inside the other and/or can be disposed at least partially concentrically one in the other, which piston elements preferably can be moved along a common longitudinal axis in a translatory manner relative to each other.

28. The magnetorheological force transmission device according to claim 2, wherein the transmission gap is disposed at least partially between the two device parts, and in that the two device parts are configured either such that they can be moved past each other in the form of a shear movement, or are configured such that they can be moved towards each other and away from each other in the form of a squeezing movement.

29. The magnetorheological force transmission device according to claim 2, wherein the configuration as damping device, in particular as electrically actuatable damping device and/or as impact damper, shock absorber or vibration damper, fixing or locking device, safety switch, haptic device or as man-machine interface element.

30. The magnetorheological force transmission device according to claim 1, wherein the device is configured for use as a coupling, a brake, or a damping device.

31. A magnetorheological torque transmission method in which two device parts which are separated by at least one transmission gap for torque transmission which is filled at least partially with a magnetorheological material are rotated relative to each other about an axis of rotation, and in which a magnetic flux is produced at least in one part of the transmission gap, wherein the magnetic flux is produced in at least one part of the transmission gap by means of at least one electromagnet and at least one permanent magnet with variable magnetisation, the magnetisation of the permanent magnet with variable magnetisation being adjusted by changing the coil current of the electromagnet.

32. A magnetorheological force transmission method in which two device parts are moved essentially in a translatory manner relative to each other, and in which a magnetic flux is produced at least in one part of a transmission gap for force transmission which is filled at least partially with a magnetorheological material and is disposed at least partially in one of the device parts, at least partially in both device parts and/or at least partially between the two device parts, wherein the magnetic flux is produced in at least one part of the transmission gap by means of at least one electromagnet and at least one permanent magnet with variable magnetisation, the magnetisation of the permanent magnet with variable magnetisation being adjusted by changing the coil current of the electromagnet.

33. The magnetorheological transmission method according to claim 31, wherein the magnetic flux in the transmission gap is preadjusted by means of at least one non-magnetic insert.

34. The magnetorheological transmission method according to claim 31, wherein a magnetorheological transmission device according to claim 1 is used.
